(19) United States
(12) Patent Application Publication
(10) Pub. No.: US 2018/0155251 A1
(43) Pub. Date: Jun. 7, 2018

(54) PRE-FORM BONDING AGENT FOR MAKING VITRIFIED PRODUCTS

(71) Applicant: THOMAS P. MALITAS, HOLDEN, MA (US)

(72) Inventor: THOMAS P. MALITAS, HOLDEN, MA (US)

(21) Appl. No.: 15/822,196

(22) Filed: Nov. 26, 2017

Related U.S. Application Data
(60) Provisional application No. 62/429,825, filed on Dec. 4, 2016.

(51) Int. Cl. C04B 35/632; C04B 35/565; C04B 33/13; C04B 35/64; C04B 33/04; C04B 33/32

(52) U.S. Cl. CPC C04B 35/632; C04B 35/565; C04B 33/1305; C04B 2235/3826; C04B 33/04; C04B 33/32; C04B 2235/349; C04B 35/64

(57) ABSTRACT

Pre-form bonding agent for making vitrified products, said agent including sugar.

### CROSS-REFERENCE TO RELATED APPLICATIONS

This application claims the benefit under 35 U.S.C. 119(e) of both U.S. Provisional Application No. 62/429,825 filed Dec. 4, 2016, which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

The present invention pertains to a preform binder for forming vitrified products.

### BACKGROUND OF THE INVENTION

A free-flowing induced pour mix is required for making a vitrified cool Silicon Carbide (SIC) grinding wheel and for making insulating SIC bricks or segments. I was given the task to develop this by using ⅛ inch polyethylene particles as a pour media. Many items were used unsuccessfully for a few months, until at coffee, by myself, the word “glue” came to my mind. I needed a rolling action for this process, I summoned the yard department to get me a Mason's cement barrel. I then gathered the other needed equipment and started the procedure. I sprayed polyethylene particles with acetone, and the polyethylene particles slowly became sticky. I threw in the Clay Bond powder, and the Clay bond powder stuck to the polyethylene-acetone media particles. Then the SIC was added and adhered to the clay powder-media particles and I successfully pelletized the mix. Surprised and elated, I took a handful of the pellets to the assistant Dir. of R&D who had assigned me the task and said “look”! I thought his eyes would pop out and he said “how did you do it”. He was so surprised because the project had been going on for 20 years unsuccessfully.

A few months later we were disappointed when the EPA rejected the polyethylene as being an atmospheric pollutant.

For the next 50 years, Norton Co. and then Saint-Gobain have been using walnut shells as pour medium, but variations in atmospheric humidity contributes to instability and resulting rejections. Because this is a wet mix, it is not very desirable.

An object of some embodiments of the present invention is to provide an improved, more effective, less poluting, and more efficient preform binder for the formation of vitrified products.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

On Jul. 7, 2015, while having coffee in the morning by myself, hard candy, as a pour medium, came to my mind. When sprayed with water or a blast of steam, the surface of sugar candy particles would dissolve and form a sugar-candy-based adhesive. They would become sticky just as polyethylene would, but without the environmental problems. This problem has been going on for about 70 years and I think this is the solution. Although sucrose, and other mono- and di-saccharides that form adhesive water solutions work, all water-soluble carbonhydrates that form adhesive water solutions work.

### BRIEF DESCRIPTION OF THE DRAWING

FIG. 1 is a flow chart of a process embodying the principles of the present invention.

FIG. 2 is a top view of a preform embodying the principles of the present invention.

FIG. 3 is a front elevation view, in cross-section, of a preform embodying the principles of the present invention, as shown along view III-III on FIG. 2.

### DETAILED DESCRIPTION OF THE INVENTION

On Jul. 7, 2015, while having coffee in the morning by myself, hard candy, as a pour medium, came to my mind. When sprayed with water or a blast of steam, the surface of sugar candy particles would dissolve and form a sugar-candy-based adhesive. They would become sticky just as polyethylene would, but without the environmental problems. This problem has been going on for about 70 years and I think this is the solution. Although sucrose, and other mono- and di-saccharides that form adhesive water solutions work, all water-soluble carbonhydrates that form adhesive water solutions work.

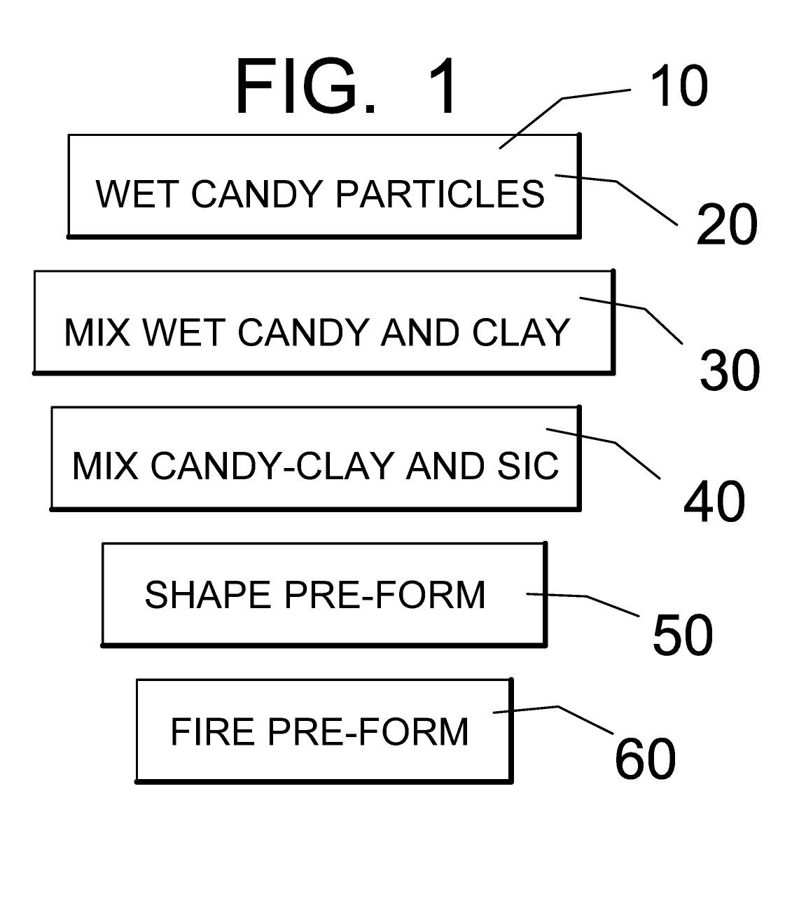

Referring to FIG. 1, the process 10, forms vitrified products of clay and silicon carbide.

In Step 20, wet candy particles are formed

In Step 30, wet candy and clay are mixed.

In Step 40, wet candy-clay mix is combined with silicon carbide particles.

In Step 50, wet candy-clay-SiC mix is formed into a preform.

In Step 60, the preform is fired to form a vitrified product.

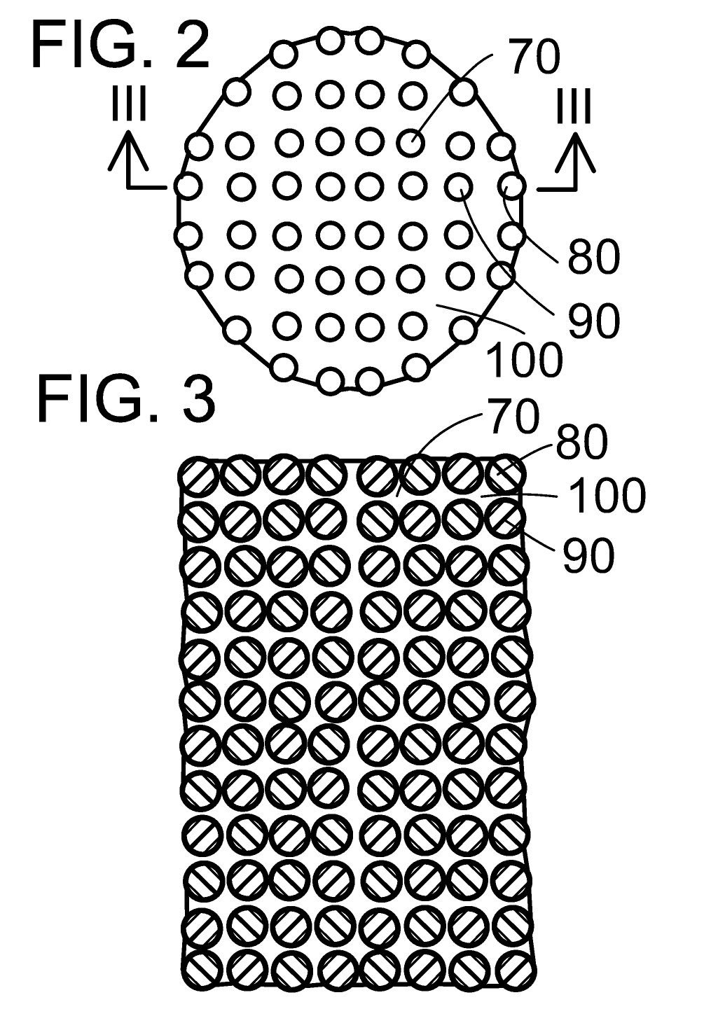

Referring to FIG. 2, the preform 70, is formed of a matrix of clay particles 80 and Silicon Carbide particles 90, and the interstitial spaces between the particles are filled with candy 100 that holds the matrix in its shape.

Referring to FIG. 3, the preform 70, shown in a cross-sectional view, is formed of a matrix of clay particles 80 and Silicon Carbide particles 90, and the interstitial spaces between the particles are filled with candy 100 that holds the matrix in its shape.

When the preform is fired, the candy 100 gasifies and escapes, and the clay particles 80 and Silicon Carbide particles 90 sinter into a solid and durable matrix.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. Pre-form bonding agent for making vitrified products, said agent including sugar.

2. A vitrified product, made with a pre-form bonding agent including sugar.

3. A method of making Vitrified Products, using a pre-form bonding agent including sugar.
